(19) United States
(12) Patent Application Publication
(10) Pub. No.: US 2021/0142432 A1
(43) Pub. Date: May 13, 2021

(54) SYSTEM AND METHOD FOR PROVIDING AN ON-LINE SERVICE TO FACILITATE REGULATORY COMPLIANCE

(71) Applicant: accenaGroup L.L.C., Orem, UT (US)

(72) Inventors: Donald H. Reynolds, Orem, UT (US); Ryan M. Dickson, Orem, UT (US); Vard S. Lott, Riverton, UT (US); Russell H. Day, Orem, UT (US); Ryan K. Jones, Farmington, UT (US); Amir A. Arafat, Bluffdale, UT (US); Jared K. Uffenorde, Herriman, UT (US); James H. Tolman, Orem, UT (US)

(21) Appl. No.: 16/987,752

(22) Filed: Aug. 7, 2020

Related U.S. Application Data
(63) Continuation of application No. 16/879,719, filed on May 20, 2020, now abandoned.
(60) Provisional application No. 63/027,146, filed on May 19, 2020.
(60) Provisional application No. 62/933,171, filed on Nov. 8, 2019.

(51) Int. Cl. G06Q 50/26; G06F 21/62; G06F 16/93; G06F 3/0482

(52) U.S. Cl. CPC G06Q 50/26; G06F 21/6218; G06F 2221/2141; G06F 3/0482; G06F 16/93

(57) ABSTRACT

The present invention is a system and method for providing a multi-User and multi-device interface that functions as a single Cloud-based access point for Regulators, Operators and the general public to information regarding all aspects of regulatory compliance for any number of Sites or projects that are subject to regulatory oversight, wherein access to the data is strictly controlled so that only portions of the data are visible to a User based on pre-defined access rights, and wherein the system is ultimately designed to facilitate regulatory compliance by providing access to forms, permits and all other documentation needed so that a Site or project can be inspected and the proper reports may be generated for the activities of the Operator at a Site or project.

### CROSS-REFERENCE TO RELATED APPLICATIONS

This application is a continuation of U.S. patent application Ser. No. 16/879,719, filed May 20, 2020, titled “SYSTEM AND METHOD FOR PROVIDING AN ON-LINE SERVICE TO FACILITATE REGULATORY COMPLIANCE,” which claims the benefit of U.S. Provisional Patent Application Ser. No. 63/027,146, filed May 19, 2020, and which also claims the benefit of U.S. Provisional Patent Application Ser. No. 62/933,171, filed Nov. 8, 2019, titled “SYSTEM AND METHOD FOR PROVIDING AN ON-LINE LEASING SERVICE TO FACILITATE REGULATORY COMPLIANCE,” which are hereby incorporated by reference herein in their entirety, including but not limited to those portions that specifically appear hereinafter, the incorporation by reference being made with the following exception: In the event that any portion of the above-referenced applications are inconsistent with this application, this application supersedes said above-referenced applications.

### BACKGROUND

### Field of the Invention

This invention relates generally to regulatory compliance. More specifically, the invention relates to a system that enables Regulators and those being regulated to have real-time and role-based access to the same repository of data, workflows, events, artifacts, and corrective actions in order to facilitate regulatory compliance.

### Description of Related Art

Federal, State, and local governments are legislative bodies that create laws for the public good. Regulations are then written to implement the specifics of a particular law. Government agencies are often created to enforce the regulations and ensure compliance by those entities that are subject to the regulations. Unfortunately, demonstrating compliance with regulations may be a convoluted, complex, and expensive task that requires substantial resources to perform actions in order to follow regulations, to schedule actions and then document the entities' compliance.

In order to understand how compliance with regulations is met, it is helpful to recognize that there are two sides that must communicate and coordinate actions in order to have compliance with regulations. The first side is the Regulator who is tracking compliance. The Regulator may be any individual, group or entity that regulates. For example, the Regulator may be a government organization or a private company.

The second side is comprised of those who are being regulated and will be hereinafter referred to as the Regulatee. The Regulatee is any individual, group or entity that is regulated.

For the purposes of this document, a specific example will be given of a law that is being regulated. However, it should be understood from the outset that the principles of the embodiments of the invention are applicable to any activity or project that is regulated and has a Regulator and a Regulatee.

Specifically, a software program called ComplianceGo™ was originally created in order to track compliance with regulations that were written in order to enforce the Federal Clean Water Act. At least a portion of the Federal Clean Water Act is directed to regulating the stormwater industry.

A collection of structures designed to gather stormwater and discharge it into local streams and rivers is referred to as a Separate Storm Sewer System. A Separate Storm Sewer System is often a Municipal Separate Storm Sewer System (MS4). It is referred to as a “separate” system because it is not connected to a sanitary sewer system which drains wastewater from inside a home to a sewage treatment facility or a private septic system.

One of the main characteristics of the prior art is that traditional methods of administration on projects with dual responsibilities between a Regulator and a Regulatee is for each party to provide their own method of compliance and to later share data only during an audit or other regulatory visit. This method has proven insufficient in providing accurate and timely information to Regulators who may need to respond immediately to particular conditions or situations on a project.

Accordingly, it would be an advantage over the prior art to provide a software-based system that unifies the data regarding a particular project, and then provides differentiated access to that data based upon the role of the party seeking access.

### BRIEF SUMMARY

The present invention is a system and method for providing a multi-User and multi-device interface that functions as a single Cloud-based access point for Regulators, Regulatees and the general public to a common database of information regarding all aspects of regulatory compliance for any number of Sites or projects that are subject to regulatory oversight, wherein access to the common database of information is strictly controlled so that only portions of the database are visible to a User based on pre-defined access rights, and wherein the system is ultimately designed to facilitate regulatory compliance by providing access to forms, permits and all other documentation needed so that a Site or project can be inspected and the proper reports may be generated for the activities of an Operator of the Site or project.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a screen that may be shown on a display of a computing device and is a company dashboard that gives an overall view of all Sites and projects of a specific company.

FIG. 2 is a screen showing an example of a Company Page that may include Company information, People and Roles, and Reports.

FIG. 3 is a screen showing a Custom Form Builder in an Edit mode.

FIG. 4 is a screen showing the Custom Form Builder of FIG. 3 but in a Preview mode where the selections made in the edit mode may be seen.

FIG. 5 is a screen showing a Site page. The Site page may provide Site information such as location. The Site page may also provide access to Site Tools and Reports.

FIG. 6 is a screen showing an Inspector Dashboard. The Inspector Dashboard may only show those specific Sites for which the Inspector has direct responsibility.

FIG. 7 is a flowchart that illustrates the workflow when an inspection must be performed at a specific Site.

FIG. 8 is a diagram that shows the ownership structure of the various entities involved.

FIG. 9 is an Access Control flowchart that explains who has access to a Site.

FIG. 10 is a block diagram of the components of a system that can operate the ComplianceGO software program and provide access to a common database.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

The embodiments of the invention are directed to compliance of Sites or projects (hereinafter to be referred to as just “Site(s)”) with the stormwater provisions of the Federal Clean Water Act. However, while the examples provide context for the embodiments, it should be remembered that the present invention may be used for a variety of different industries, both privately and publicly regulated, as well as corporate or private non-regulatory entities for use in internal processes and governance.

Stormwater regulations of the Federal Clean Water Act are put in place to help keep receiving waters (streams, rivers, tributaries, city storm drain systems, etc.) clean from polluted runoff which consists of sediment (sediment is nutrient loaded with phosphorus), hydrocarbons, and other pollutants. Stormwater is only one of many components of water quality and is not associated with wastewater. Rather, stormwater is rain or snow melt that runs off of communities, construction sites, neighborhoods, roads, etc. and discharges into nearby waters.

The EPA implements the stormwater regulations derivative of the Federal Clean Water Act through the NPDES (National Pollutant Discharge Elimination System). This is a permitting system that contains regulations associated with the permits, just as obtaining a driver's license (permit) requires agreement with all the regulations (traffic laws, etc.). However, it should be understood that many states have been granted primacy of the program specific to each state.

For example, in the state of Utah, the state administers a permit with regulations specific to Utah that must be at least as stringent as the EPA permit and regulations. Any construction project that disturbs 1 acre or greater of land or is part of a common plan of development that is 1 acre or greater in disturbance must obtain a UPDES (Utah Pollutant Discharge Elimination System which is authorized by the NPDES). Additionally, the state and the EPA require any business that has outdoor maintenance, storage, fueling, or similar activities to also have a permit for these types of activities.

Obtaining one of these permits for each project ideally means that the regulations will be followed. The regulations require “self-monitoring records of activity” such as stormwater pollution prevention plans that outline the challenges on-site, the pollutants, and what the permittee is going to do to properly manage these pollutants, inspections, action and maintenance logs, site map updating, sign posting requirements, and more.

Furthermore, cities within certain population densities must also regulate the permittees and their activities above and beyond what the state and EPA must also regulate. This includes regulatory inspections, monitoring of documents and permits, and basically making certain that the permittees are doing what they are supposed to do.

In summary, compliance with regulatory requirements for any project that involves a highly regulated activity is a complex task that involves many different parties that all may need access to the same information. Unfortunately, there has been no existing common database of information (hereinafter known as the “common database”) or system for providing such access.

For example, while it is useful for both a Regulator and a Regulatee to examine the progress on a project from their different perspectives, there has existed no repository or common database that could be accessed by the different parties. Furthermore, the different parties may require access to different parts of the information. Unfortunately, there has been no means for restricting access based on need. Accordingly, the information has been stored separately. Obviously, separate storage of information may lead to problems such as synchronization differences when one database has data that is older than another database.

A first aspect of the embodiments of the invention is to provide a mobile-friendly, web-based regulatory compliance software program that uses Cloud-based data storage. By making the data easy to access using a Cloud-based repository or common database all permittees such as private companies with permits (Regulatees) and the cities and states that are regulating (Regulators), are able to manage the required documents that must be “on-site”, the permits, the inspections, the action items, the maintenance logs, the updated maps, etc., in order to achieve compliance.

The embodiments of the invention connect the permitted Site to the regulatory entity and allow both the Regulator and the Regulatee to see what they need to see on a Site while documenting inspections within the regulation compliance software program that can be shared with each other so that actions can be completed, inspections and actions can be signed and documents corrected, so that everyone may achieve compliance with the regulations.

The embodiments of the invention make sharing of the common database possible by providing different access for different types of Users, including view-only access for anyone that must see these items without having to even log in to the system.

A significant feature of the embodiments is that the updated ComplianceGo software enables coordinated actions by the Regulator and the Regulatee on a single Site while maintaining separation of duties and separation of sensitive data in the common database.

The embodiments of the invention will be explained by demonstrating the features of the various modules within the updated software program. The features of the software program may include the modules GOConnect, GOInspect, GOAdmin, GOCorrect, GOWeather, GOForms, GOBranding, GOMaps, GOAssets and GOManage.

GOConnect

The module GOConnect may be divided into four functions. These functions include regulatory separation of duties, User access, public interface, and backup role support for User duties.

Beginning with the regulatory separation of duties, all known prior art (competitors and previous versions of ComplianceGo software) have focused on providing tool sets either for the Regulators or for the Regulatees. The embodiments of this invention unify all workflows and data into a single tool (the regulatory compliance software program in the embodiments of the invention) for the first time, enabling Regulators and Regulatees to have real-time and role-based access to the same repository of data, workflows, events, artifacts, corrective actions, etc.

The embodiments also define and separate the role of each User so that each User may have precise access to assets, workflow data and artifacts according to the requirements designated by the administrator of a Site with regards to regulatory compliance or oversight.

Users that are affiliated either with Regulators or Regulatees may be assigned certain roles for each Site, Entity, workflow, or artifact based on their duties for each, and specific to their assigned duties in achieving and maintaining compliance for Sites.

Users may be defined as any individual, organization or other set of individuals who interact with the embodiments of the invention.

Regulator Users perform oversight, workflows, inspections, audits and other tasks as required by the pertinent governing body, while Regulatee/Operator Users, who may not have access to certain oversight data or workflows, may be assigned to perform administrative and other functions, inspections, and tasks specific to their role on a Site.

For example, these Operator Users may be tasked with completing inspections, creating corrective action tasks, or completing those corrective actions, etc. These features allow all parties to assess at a glance (and at different levels of granularity) all compliance, work to be done, work lacking, and overall compliance with laws, regulations, rules, permits, requests, recommendations, requirements, reporting, and maintenance standards.

Likewise, a unique and advantageous feature of the embodiments of the invention may strategically restrict access to data, artifacts, events, workflows, corrective actions, assets, etc. based on the Users, Sites, Entities, role and assigned duties.

The embodiments of the invention may also configure and grant User permissions on an individual basis, and these permissions may also be selectively inherited based on the User's Role or affiliation to an Entity.

While both the Regulator and the Regulatee (Operator) complete inspections, tasks, corrective actions, etc., on the Site separately, they may be able to see the data in real-time where applicable to thereby maintain Site compliance at all times.

Furthermore, inspections, tasks, corrective actions, and related schedules may be customized and parameterized at either the User or the Role level. Thus, support for unique Users, Roles and Duties may be based on regulatory requirements. Within the scope of a Site or Asset, each User may have certain regulatory requirements assigned and supplied specifically to them.

For example, a state-level Regulator may require special access in order to conduct limited tasks on a Site and to track compliance based on state or national requirements. These tasks may only be available to be completed by a User possessing the required level of permission. In contrast, a local regulatory agent may require separate tasks on a different schedule based on different requirements. The schedules and requirements for each Regulator may be uniquely associated and assigned to the correct User. Site or facility owners, operators, contractors, sub-contractors, inspectors, consultants, regulators, and auditors may therefore have individualized, unique access to each Site to complete their individual requirements.

The concept of having regulatory separation of duties assigned to different Users on the invention is only useful if the Users may be granted differentiated access to the common database. One significant advantage of the embodiments of the invention therefore includes different User access. Thus, controlled access to Site regulatory documents, functions, reports, histories, plans, maps, permits, action items, etc. may be granted to different parties based on their Role.

For example, the embodiments of the invention enable specific access to required functions and information to Non-System Users. Specific items may also be viewable to individuals without specific roles on the Site when viewing the Site through a uniquely generated URL. For example, a Non-System User may receive an email with a URL link that enables the User to see data from the ComplianceGO software program. However, viewable URL links may be permanent or temporary, based on User customization. Workflow Elements may also be communicated to any Recipient by any Communication Service. The Recipient may be given the ability to complete tasks or otherwise interact with the system.

Workflow Elements may be defined as any functions, tasks, corrective action items, requests, renewals, remittances, signatures, reports, inspections, schedules, checklists, documents and permits.

The embodiments of the invention also include intuitive, web-responsive interfaces and tools to manage Workflow Elements for non-Users based on regulatory duties to convey information to Recipients and allow the Recipients to complete corrective actions and otherwise interact across many Entities based on the means of communication and the identity of the Recipient.

For example, a Recipient may be identified by their unique email address and be given the capability of performing functions and tasks for multiple Entities within the system without the requirement of creating a User account. The email that is sent to the User may include a hyperlink or URL that gives the User access to specific data that the Recipient has been authorized to access even though the User never logs in to the system.

Accordingly, the embodiments of the invention include a variety of different User roles. These User Roles may be as follows.

The first type of User is a Viewer. A Viewer may be an authenticated User that can log in and view an entity or Site depending on what Sites the Viewer has been added to. The Viewer may only view and cannot perform any functions on the Site. While the Viewer is someone who is logged in to the system, the Role of the Viewer has no functionality other than viewing Sites and specific data.

The second type of User is an Inspector. An Inspector may be an authenticated User that may see a dashboard for Sites that have been assigned to them. They may look at data for the Site that they want to go to and complete inspections and other functions at the Site level.

The third type of User is a Backup Inspector. The Backup Inspector may be an authenticated User with the same functionality as an Inspector, but with Sites for which the role is hidden unless the Backup Inspector toggles to bring them forward. This type of User allows for backup inspection coverage on Sites.

The fourth type of User may be an Editor. The Editor may be an authenticated User that can manage an entity or Site or MS4. This management may be at a division, company, or director level. The Editor may be able to create new Sites, divisions, or companies at or below the level for which their Editor access is granted. An Editor may also create forms and permits, assign inspections, and do other Site activities. The editor may also perform Admin (audit-level) inspections but may not perform regular site inspections.

The Operator Editor, as Editor for a Company, has access to all Company functions as well as all Division and Site functions for all Divisions and Sites under the Company. As new Sites need to be entered, it is the Operator Editor who adds them. As new people require access, the Operator Editor creates new Users and uses the different Company Roles to give the Users the appropriate types and levels of access.

For each Site under the Company, The Operator Editor determines which Company Notification Recipients will receive which Notifications and by doing so ties all Users into the web of automated information sent out by the system.

Using the Company Dashboard, The Operator Editor has an overview of compliance on all Sites under the Company. The Division Dashboards provide the same scope of information but narrowed down to a single Division.

At any time, the Operator Editor may pull compliance reports based on information from the whole Company or a specific Division or Site under the Company. One example of these reports is one that shows all Action Items in the past 90 days for all Sites within the Company or a Division or for a specific Site. They also have the ability to share access to the Public (View-Only) Interface for any Site under their Company.

The Regulatory Editor, as Editor for an MS4, has access to all Municipal functions for all Sites within their jurisdiction, whether the Site is under the MS4 or a Company that subscribes to ComplianceGO. The Regulatory Editor may create new Users as needed, but unless the Site is under the MS4, they are restricted to assigning people to Municipal Roles. The same is true for Notification Recipients, only allowing Municipal Notification Recipients to be added and edited.

For Divisions and Sites under the MS4, The Regulatory Editor additionally has all the functions of The Operator Editor. This capability allows them to grant access to private companies who are working within their jurisdiction, but who do not subscribe to ComplianceGO. These companies are then able to function as if they were The Operator Editor for a Division of the MS4, assuming The Regulatory Editor grants them the appropriate access.

A Municipal Dashboard grants The Regulatory Editor an overview of compliance on all Sites within the municipality's jurisdiction whether they are under the MS4 or the Company.

For Sites within their jurisdiction, the Regulatory Editor may pull compliance reports based on information from all of the Sites or from specific Sites. For Divisions under the MS4, they can additionally pull Division level reports as explained in regard to the Operator Editor.

They also have the ability to share access to the Public (View-Only) Interface for any Site in their MS4's jurisdiction.

The fifth type of User may be a View Only (Public) User. The View Only (Public) User may be a non-authenticated or logged-in User that may only view limited Site information. The View Only (Public) User may primarily allow Regulators who are not system Users to come in and see the documents, permits, maps, and inspections without being able to edit anything. However, the View Only (Public) may be any person that is not associated with the Site.

A sixth type of User may be a Site Manager. The Site Manager may be allowed to have all of the same functionality as the Inspector except for being able to perform inspections.

A seventh type of User is a BMP Maintainer. The BMP Maintainer User may be able to log into the system and easily mark off all of the action items that they have been completed without being able to edit or do anything else on the Site.

While some of the duties of each type of User has been specified, it should be understood that the Roles of each User may be altered or expanded, or that Users may also have multiple User Roles that they may be able to switch between as needed. The Roles may be defined as all of a User's access, capabilities, permissions, and functionality within the ComplianceGO software program.

While the embodiments of the invention may be directed to specific types of Users and the Roles that they play, the Public View-only interface is also a substantial advantage of the invention. The public interface enables the viewing of notes, files, maps, etc. for every Site or regulated asset and for all non-system, Public Users.

However, Non-logged-in Users using the public interface may have limited ability, or no ability at all, to edit or leave comments using this publicly-available system.

The public interface may have a User or administrator-configured expiration of public access via a time limit or other criteria.

The Public View of a Site and/or other assets may be User or administrator-configurable at the granular, component level, to include what is pertinent for public consumption and may exclude sensitive internal data. Thus, the public interface may hide areas that apply to other roles in the system.

In addition to the Site, a QR code or other widely-recognized access mechanism may also provide direct access to the public information.

Another way to enable public access to public information may be through a direct, deep, shareable HTTP hyperlink.

One particular feature of the different User types is the back-up Role Support for User duties. In other words, a subcategory of User Role may be Secondary support for Users in order to complete tasks and inspections assigned to another User. For example, a Back-up Inspector Role may include its own interface allowing a User to keep their main interface free of tasks and inspections they do not typically perform.

Furthermore, Inspectors may be able to assign tasks to a User who has a backup role such as Back-up Inspector. These assignments may be configured manually or may be triggered automatically based on business rules. For example, the system might determine that a User is overloaded or unavailable, and thus take action to engage a Backup User. Alternatively, the Backup User may simply engage in backup tasks whenever they so choose.

The interface that a User may have into a Site or project has been mentioned above. One particular advantage of the embodiments of the invention is the interface that may be provided on various platforms to Users of the system. Some examples of an interface that may be provided by the system are shown in the following figures. It should be understood that the figures are only examples, and the embodiments should not be considered as limited to the examples shown.

Before providing more explanations regarding the other modules of the ComplianceGO software program, it is useful to examine some screenshots that display advantageous features of the embodiments of the invention.

FIG. 1 is a screen that may be shown on a display of a computing device. The screen may be part of a dedicated ComplianceGO software program running directly on the computing device, or the ComplianceGO software program may be shown in a web browser that is accessing the compliance software program that is running on a remote server.

FIG. 1 is displaying a company Editor Dashboard 10 that gives an overall view of all Sites and projects of a specific company. The company name 12 may be identified in the Editor Dashboard 10. As shown, a pin 14 is disposed at each Site on a map 16. The size of the map 16 may be adjusted according to User preferences. The Editor Dashboard 10 may include a status bar in a column on the left-hand side of the software program with useful information regarding all the Sites in general but not for specific Sites. If the User has the correct permissions or access rights, a specific Site may be selected to review more specific data of the specific Site.

Some of the useful information that may be included in the Editor Dashboard 10 may include Open Action Items 18 and action items that are Past Due 20. Another section may be dedicated to Permits 22 and may provide such useful information as the number of permits that are expiring 24 within the next 45 days. It should be understood that the number of days until permits expire may be modified if more advance warning is desired. The Permits 22 may also show the number of permits that have expired 26.

The next section may be dedicated to Sites Missing SWPPP's or Maps 28. SWPPP's are Stormwater Pollution Prevention Plans. A first section may be the number of Sites that are Missing SWPPP's 30, followed by the number of Sites that are Missing Maps 32.

The information displayed on the Editor Dashboard 10 may not always be the same information. The Editor Dashboard 10 may be configured to only show the information that is allowed for a particular type of User. The User that is presently logged into the ComplianceGO software program is an Editor with rights to view the Site summaries that are shown in the Editor Dashboard 10.

FIG. 2 is a screen showing an example of a Company Page 38. This Company Page 38 may include Company information 40, People and Roles 42, Managed Forms 44 and Reports 46. The Company Page 38 also shows the User who is currently logged in to the software program. Clicking on the left facing arrow 48 next to the company name 12 will cause the software program to return to the previous page which was the Editor Dashboard 10.

FIG. 3 is a screen showing a Custom Form Builder 50 in an Edit mode 52. Because the User is an Editor, the User has rights to create new forms 54 that may be used by the ComplianceGO software program. The new forms 54 may only be available to select Users or to all Users, depending on where the new form 54 is used. The Editor will determine how the new form 54 is used and who may use it. The Editor will also give the new form 54 a name so that it may be easily identified, and its function understood.

The new form 54 being created may have numerous fields for data entry such as buttons, check boxes, etc. The Editor may drag and drop the form components from the list of form components 56 in the right column. These form components 56 may include but should not be considered as limited to a checkbox, divider, dropdown menu, guide items, number input, list items, redo, text, text input, textures, title, and toggle buttons.

The Editor of the new form 54 may save the form while it is being created by using a save form 58 button.

FIG. 4 is a screen showing the Custom Form Builder 50 of FIG. 3 but in a Preview mode 60 where the selections made in the edit mode 52 may be viewed in a final format. The top section of the display shows the controls for switching between editing or previewing the new form 54, while the bottom section of the display shows the new form 54 in the preview mode 60. The Editor may return to editing or viewing the type of data that may be entered using the selection controls 62.

FIG. 5 is a screen showing a Site page 64 if the User selects a Site from the map 16 on the Editor Dashboard 10 shown in FIG. 1. The Site page 64 may include Site Information 66 that should not be considered as limited to Site status, Site address, Site longitude and latitude coordinates, time zone, a close-up map, email addresses of those working at or responsible for the Site, the Division of the Company, and the associated MS4.

The Site page 64 may also provide access to Site Tools 68, Reports 70 and Administrative Inspections 72. It should be remembered that Site information 66, Site Tools 68 and Reports 70 may vary depending on the access rights of the User who is accessing the Site page 64. The Site Tools 66 may include but should not be considered as limited to action items, notification receipts, Site permits, documents, people and Roles, forms, schedules, weather events and a Site map.

The Reports may include but should not be considered as limited to an action log report, a map history report, and an inspection weather report.

FIG. 6 is a screen showing an Inspector Dashboard 74 from the ComplianceGO software program. The Inspector Dashboard 74 may only show those specific Sites over which an Inspector has direct responsibility. This Inspector Dashboard 74 appears different from the Editor Dashboard 10 that is shown in FIG. 1.

The Inspector Dashboard 74 may include an Inspections List 76. The Inspections List 76 may include but should not be considered as limited to a list of a number of the Open or Late Action Items 78, the Expiring or Expired Permits 80, a list of Sites over which the Inspector has responsibility 82, and an Inspector map 84 that shows the locations of all the Sites over which the Inspector has responsibility.

GOInspect and GOAdmin

The GOConnect module was described above to explain that Users are defined in order to implement the regulatory separation of duties. The next modules to be described in the ComplianceGO software program are the GOInspect and the GOAdmin modules. The embodiments of the invention implement these modules to provide Inspection and Admin functions.

The system implemented in the embodiments of the invention may include the ability to switch into an Inspector Mode of the GOInspect module. The Inspector Mode changes the interface of the ComplianceGO software program to an inspector-centric and mobile-friendly experience. The system enables inspections to be conducted on mobile devices by formatting the display to accommodate a smaller display screen.

Inspections may be conducted and stored in the cloud-based common. The data from the inspections may then be printed and archived in the format(s) specified by the Regulator, such as in State-specific or Entity-specific PDF forms.

All inspection activity may be immediately stored from the mobile device to the Cloud in the common database for easy access by all parties. The mobile device may use a cellular or a Wi-Fi connection to upload the data. Inspections may also be conducted when the mobile Device of the Inspector is offline, and then synced to the Cloud as soon as the Inspector is in a location where data may be uploaded to the Cloud. This feature may be critical when conducting an inspection in new and/or remote areas with intermittent Internet or cellular coverage.

The Inspector Mode is web-responsive such that Users may work either on mobile devices such as phones or tablets, or on a desktop computer. The Inspector Mode may determine which device is being used and display the information from the ComplianceGO software program using the appropriate format.

Inspectors have a specific dashboard as shown in FIG. 6 that allows them to see what is due that day and to start those inspections for those Sites. The Inspector dashboards may also show weather event activity in a GoWeather module page, permit expiration information, action items (corrective actions) that are overdue, and Sites missing maps or plans, and any other information pertinent to the regulatory compliance of a Site.

The system also allows switching from the Inspector Mode into an Editor Mode. This switch will likely change the interface to an administrator-centric interface, allowing management of Sites, Entities, Users, Roles, Events, Inspections, Permits, Forms, etc.

Editors may have access to a dashboard such as the one shown in FIG. 1 that allows them to see what is due that day and easily start inspections for those Sites. Editors and other Users may customize their individual dashboards to display the information that is most critical to them.

Editor dashboards 10 may also show GoWeather event activity, permit expiration information, action items (corrective actions) that are overdue, and Sites missing maps or plans, and other information pertinent to the regulatory compliance of Sites and Entities.

In the GOInspect and GOAdmin modules, the Operator Editor assigns Users the Company Roles of Inspector or Backup Inspector for Sites under their Company. They also assign, access, and complete Administrative and Company Inspections for all Sites under the Company.

At any time, The Operator Editor can switch to the Inspector or Backup Inspector Role to see those Roles' respective Dashboards. These Dashboards are separate from the Company Dashboard and provide a quicker overview of compliance on those Sites where they are assigned the corresponding role.

The Site Inspection History is also available for all Sites under their Company and contains all Inspections for the site, including Administrative, Municipal, and Company.

The Regulatory Editor assigns Users the Municipal Roles of Inspector or Backup inspector for Sites within their MS4. They also assign, access, and complete Municipal Inspections for all Sites within their MS4.

For Sites under the MS4, the Regulatory Editor additionally has all the functions of The Operator Editor. This feature allows them to grant access to private companies so they can conduct their Company Inspections on ComplianceGO.

At any time, the Regulatory Editor can switch to the Inspector or Backup Inspector Role to see those Roles' respective Dashboards. As with The Operator Editor, these provide a quicker overview of compliance and are limited to the Sites where The Regulatory Editor is assigned one of these Roles.

The Site Inspection History is also available for all Sites within their jurisdiction, whether it is under the MS4 or a Company.

GOCorrect

In the GOCorrect module, The Operator Editor assigns Corrective Actions on their Company's Sites, usually during an inspection, and provides schedules for completing these Actions. The Actions can then be communicated to Notification Recipients.

The Operator Editor may also complete these Action Items either by logging in or by using the Task Completion via Communication Service. At any time, they may view all Action Items that have ever occurred on the Site.

On all sites within the municipality, The Regulatory Editor assigns Corrective Actions and provides schedules for completing these Actions. The Actions can then be communicated to Notification Recipients.

The Regulatory Editor may also complete these Action Items as described in the Operator Editor, but as a Regulator, it is more common for them to rely on the Company and its designated individuals to complete the Action Items. The Regulatory Editor may view all Action Items that have ever occurred on any Site in their jurisdiction.

For Sites they have been assigned, the Inspector assigns Company Corrective Actions along with corresponding schedules for these Actions. They can also communicate Corrective Actions to Company Notification Recipients. Additionally, they can view and complete all Action Items on the Site as described in The Operator Editor and The Regulatory Editor.

If they have been assigned to the Site, the Manager can view and complete all Action Items on the Site as described in The Operator Editor and the Regulatory Editor.

If they have been assigned to the Site, the Viewer can view all Action Items that have occurred on the Site. They can only complete Action Items via the Task Completion via Communication Service.

The third Party receives notice of Corrective Actions if they have been put as a Notification Recipient. They then complete these Corrective Actions through the Task Completion via Communication Service. They can only view past Action Items if they have been granted access to the Public (View-Only) Interface.

If granted access to the Public (View-Only) Interface, the Citizen (Non-System User) can view all Action Items that have been put on the Site.

Functions, tasks, action items, requests, reports, inspections, or checklists may be communicated to any Recipient via a Communication Service. The Recipient may or may not be a User of the system. The Recipient may be given the ability to complete tasks or otherwise interact with the system.

The Communication Services may include but should not be considered as limited to email, chat, text, voice, third party products, account private messaging or any other convenient communication methods.

Under certain conditions, completion of Workflow Elements may be performed by a Recipient without the need to create an account or have to log in to the system. When applicable, a reasonable assumption of identity will be required in compliance with Electronic Signature laws (i.e. unique email address, phone number, social media account private messaging, etc.)

The communication of Workflow Elements may be directed to a single Recipient or multiple Recipients, as configured in the system, or instigated by the User. Each Workflow Element may be assigned individually to the appropriate recipient(s) or assigned to all the recipients that are listed for a given task.

Workflow Elements may be made to be due at the time of an inspection or may be assigned another due date that is communicated to the designated Recipient(s).

The system also has the unique ability to customize inspection/task cycles based on regulatory requirements. For example, time periods such as every 4 business days or every other week on a specific day as well as after a certain threshold of precipitation has been met, weekly on any day and after a forecast of a certain percentage, monthly on a specific day and also quarterly after precipitation, etc.

The system may also have the unique ability to customize corrective action due dates and windows. For example, due dates may be on a specific day, within a predetermined number of hours such as within 72 hours, prior to the next business day, within 4 business days, prior to the next forecast of a particular percentage chance of rain, after the next weather event consisting of over 1 inch of precipitation, etc.

The embodiments of the system may also include intuitive, web-responsive interfaces and tools to manage Workflow Elements for non-Users based on regulatory duties to convey information to Recipients and allow the Recipients to complete corrective actions and otherwise interact across many Entities based on the means of communication and the identity of the Recipient.

For example, a Recipient may be identified by their unique email address and have the ability of performing functions and tasks for multiple Entities within the system in a convenient manner without the requirement of creating a User account.

Another feature may be the ability to add notes to action items without closing them. For example, the Dashboards 10, 72 and Site pages 64 may provide a list of corrective action items that are late, due, in-progress, available, scheduled, completed, verified, waiting verification, under revision, re-opened, or missed. The action items may be updated as Users change the status of or interact with the corrective action items.

Furthermore, notes, pictures, videos, files, and other attachments may be added to the action items at any time and are tracked within the action item itself. Users with the appropriate Role may then be able to go in and see when the action items were created, if any notes were added to the action item, and the closing of the action item.

GOWeather or RSWT

In the GOWeather module, the Operator Editor assigns triggers for their Company's Sites that will send Notifications to Company Notification Recipients according to weather forecasts or precipitation values. These same triggers can make Company Weather Inspections available. Recent weather triggers can also be viewed on all dashboards, allowing the Operator Editor to keep track of these events.

Current weather data can be seen on all the Company's Sites and can be automatically collected and added to selected Company Inspections.

For Sites in the Municipality, the Regulatory Editor assigns the same triggers for Sites that will send Notifications to Municipal Notification Recipients as described in The Operator Editor. For Sites under the MS4 in ComplianceGO, the Regulatory Editor has the same capability as the Operator Editor.

Current weather data can be seen on all Sites within the MS4's jurisdiction at any time. Recent triggers within their jurisdiction are also visible on the Municipal Dashboard, even if they were assigned by a Company.

The Inspector receives Notification of the need for a Weather Event Inspection where those have been assigned or they can see the triggered events on their Dashboards. These Inspections are then available for completion as any other Inspection.

At any time for the Sites they have been assigned, they may view the current weather data and may see it on Inspections in the Inspection History.

At any time for the Sites they have been assigned, the Manager and the Viewer may view the current weather data and may see it on Inspections in the Inspection History.

The third Party and the Citizen can view current weather data for Sites if granted access to the Public (View-Only) Interface.

Another feature of the embodiments of the invention may be the ability to provide weather information through an updated GOWeather module, or Remote Sense Weather Technology (RSWT).

The system may provide Weather Data Aggregation, Sourcing, Event Management and Error Correction. For example, the system may automatically import weather data from third party sources such as the National Oceanic and Atmospheric Administration (NOAA). Current methods of weather monitoring through NOAA's API takes data from weather monitoring stations for an estimate of rainfall amounts and forecasts that are taken from the Sites and up to miles away from the actual location.

In contrast, weather data that is closer to or at the Site may be needed. The embodiments of the invention advantageously extrapolate data from the spatial monitoring systems at NOAA. That data is usually only available for Users that visit the NOAA website. Thus, while generalized weather data may be available for a wide area that includes the Site, more specific data for the Site may be needed. The embodiments of the invention may extrapolate data from the more generalized or wider reaching spatial monitoring data from the NOAA weather database. The GOWeather module may then provide more accurate weather results for the specific Site. These weather results may be extrapolated to provide weather results that are sufficiently detailed such that data may be retrieved to within 1 meter of their actual geographical location.

In other words, while generalized weather data may be available for a wide area that includes the actual Site in question, more specific weather data may be needed for the Site in order to be able to comply with regulatory requirements. One particular advantage of this new GOWeather module is that it eliminates the need for secondary, on-Site weather monitoring equipment that is so common due to the inaccuracy of current weather data gathering methods. The GOWeather module now updates weather information that is just for the Site, is in real time, and is always available.

Weather readings may be collected with pinpoint accuracy down to the exact latitude and longitude coordinates of the places of interest.

Weather data may be imported continuously over time according to each Site's defined needs, which are configurable per Site in the system. All weather real-time, pinpoint weather data is stored for historical reference, analytics and dependent notifications, task management and display in the User interface where warranted.

The system may use weather data to trigger notifications, weather events, and other proactive User-notifying events.

The system may also provide error-handling support for alternate weather data sources, such as Site-specific weather stations, as well as retry and error-correction, round-robin and heuristics-based source selection to select the most accurate source of data, when primary or User-configured sources go offline or experience outages.

Weather data may be available via external API for contractual, licensed access by external customers, including non-regulatory entities.

The Weather system may also allow Users and administrators the ability to configure interval-based sampling and aggregation of data. For example, at the start of an inspection or task, immediately upon viewing a Site, and at a specified frequency to fulfill regulatory requirements, etc.

All types of weather data may be gathered and managed, including data pertaining to precipitation, temperature, wind, storms, forecasts, etc., based on User needs and preferences.

Multiple coordinates may be added for linear projects to give different precipitation values for different sections of the Site and to track when and where precipitation thresholds have been reached. The weather data may show time frames of when precipitation was received.

GOForms

In the GOForms module, the Operator Editor creates, edits, and deactivates Company Forms. They may also make some of these Forms accessible only to specific Divisions. These Forms are used when Administrative or Company Inspections are assigned.

The Regulatory Editor creates, edits, and deactivates Forms. These Forms are used when Municipal Inspections are assigned. For Sites added into ComplianceGO by the MS4 in ComplianceGO, they additionally have all the functions of The Operator Editor.

The Inspector uses the Forms that are assigned to their Sites as Inspections.

The Manager, the Viewer, the third Party, and the Citizen do not interact directly with the GoForms module other than to see the end result when Inspections are completed as outlined in the GoInspect and GoAdmin section.

The GOForms module may be divided into four functions. These functions include customizable forms, inspection forms allowing for high-level analysis, complex task form logic and signature customizability.

The function of customizable is possible using a custom form builder which enables a User to build custom forms as shown in FIGS. 3 and 4 and employed by Users to perform inspections or other duties.

The custom form builder may allow for a User to add and arrange any combination of form elements, including but not limited to check boxes, text input, label text, toggle controls, selection buttons, etc. Each field or form element may be configured and customized individually.

The inspector or other User may then access these custom forms with the intent to fill out the requested data. Forms may be displayed and interacted with in a format that is friendly to whatever device is used to access it, with special emphasis on portable devices including mobile phones and tablets.

Offline data access and storage may also be an important feature. Form and system input may be auto-saved real-time into the Cloud whenever a device is connected to the internet. In contrast, when a device is offline, all changes may be saved locally to the device and automatically updated to the Cloud as soon as the device is re-connected to the internet.

The system may be optionally configured to receive completed form data and transfer it into a PDF for display and print purposes, allowing the Regulator that requires that specific forms be used and submitted as part of the regulation procedures to do so. The data transfer behavior of each field or form element may be configured, customized, and mapped individually.

The system may be optionally configured to reproduce data from completed forms and transfer it into a customizable template for display and printing purposes. Users with certain permissions may be able to create their own forms for use.

Forms may be mobile-friendly but may also be reproduced in a pdf format that is customizable to the needs of the User. The system may allow editors to optionally customize the layout of their inspection reports once the inspection or task is completed. This feature may allow for customizable layout functionality in the pdf inspection report. This feature will function along with customizable forms and may allow for longer digital forms or paper saving forms for those that plan to print.

Advantageously, form layout and customization may be optionally configured by the User long after inspections are performed, in order to retroactively apply new formatting to past inspections and inspection reports.

The system may include the ability to optionally enhance (either manually or automatically) the content of the custom template, form, or pdf. For example, the system may allow for embedded links inside the User's pdf form to provide online access to updated real-time data or actionable User tasks based on report data.

The embodiments of the invention may also provide Inspection Forms that enable high-level analysis. For example, forms allow for custom sequencing and querying of data for analytical purposes. Forms may also conduct multivariate analysis of data which can be used to determine an action or result based on various entries.

For example, conducting an inspection or completing a task by filling out the form may be configured to generate a score-card based on previously identified values assigned to form items, i.e. air quality reports over time or oil field tank level analysis. Complex scoring means the same values do not have to be used each time to trigger a score or evaluation.

The system may also provide decision tree and rule-based support by allowing for complex trees of inspection and task questions and answers based on rules, response weighting and prioritization, and previous response selection.

The system may also provide complex task form logic. Task form logic allows for scoring or weighting of items and their responses on a task or complex decision-making based on the responses to task items, thereby providing the ability for Users to create and perform complex inspections and tasks.

For example, an Auto Salvage Yard may require a score-based assessment with task items weighted based on level of importance. Users may assign each task item a weight and a score may be determined upon task completion. Certain task items may not apply, and other tasks items may need to be added from a bank of available items based on the response to previous task items.

The system may also provide Signature Customizability, where this system may use complex logic to allow the User to define if a second or third signature is desired or required for a Duty or Workflow Element and to determine the requirements that must be met before the signature can be applied. The system allows the form to dynamically require a second or third signature based on this logic.

For example, the State of Colorado may require that the inspection form be signed by the environmental control manager but only after all corrective action items associated with the inspection have been completed and reviewed. The system allows for customizable certification statement language to be added based on the form when the form is created and for the certification statement language to be edited if needed.

The system may also display the inspections or other Workflow Elements that still need signatures from the correct personnel. A User's Role on the Site and the preferences for and number of signature statements chosen for the form will determine if they are able to complete a signature. The invention may notify Users who are able to complete a 2nd or 3rd signature on a Workflow Element when those signatures are required and available.

GOBranding

In the GOBranding module, the Operator Editor adds or removes logos that display on all Company Inspections. They may also add or remove logos for specific Divisions that will display in place of the Company logo in that Division.

The Regulatory Editor adds or removes logos for their Municipality that display on all Municipal Inspections conducted within the Municipality. For Sites under the MS4 in ComplianceGO, they additionally have all the functions of The Operator Editor.

The Inspector, the Manager, the Viewer, the third Party, and the Citizen do not directly interact with the GoBranding module other than to see the logo when it appears on Inspections in the Inspection History as outlined in GoInspect and GoAdmin.

Another advantageous feature of the embodiments of the invention are the ability to use a company brand. For example, the system may allow for separate, branded Cloud deployables based on the desired application, be it for Stormwater Compliance, Long-Term Compliance Inspections, Air Quality Inspections, etc.

For any deployed instance of the system, branding and theming may be supported to allow partners or third parties to clearly establish their identities in the system according to their preferences. Branding options may include logos, banners, theming, skinning, disclaimers, certifications, statements, and other info specific to a partner's Sites and Entities.

For example, a partner may configure the system to provide a custom login experience for their clients that displays partner-owned branding to their Users, including partner employees and partner clients. Partner company and divisions may configure the system to display their customized logo, include their specific forms, include specific banners, disclaimers, certifications, statements, or otherwise. Partners may also customize branding for each of their clients and manage such branding as they see fit. Partners may be able to customize and manage client Entities and dashboards, including altering and preparing default configurations for Sites, schedules, tasks, projects, functions, legends, profiles, Role access, etc. System default values and default settings are also customizable by the partner.

GOMaps

In the GOMaps module, the Operator Editor can add, edit, view, and delete Site Maps for their Company's Sites.

The Regulatory Editor can add, edit, view, and delete Site Maps for Sites under their MS4 in ComplianceGO. For all other Sites in their jurisdiction, they can only view the Site Maps.

On Sites they have been assigned, The Inspector and the Manager can add, edit, view, and delete Site Maps.

On Sites they have been assigned, the Viewer can view Site Maps.

The third Party and the Citizen can only view Site Maps if granted access to the Public (View-Only) Interface.

The GOMaps module may be divided into two functions. These functions include Google Earth or GIS overlay Site map tool and Remote Delineation of Impervious Surfaces.

The GOMaps module has the ability to overlay a map or have a Site map tool. Unique, robust mapping capabilities allow for the overlay of Site civil plans directly onto the satellite view of the Site area, while being aligned with the correct dimensions and locations.

Regulatory Site mapping functions may be added to the overlay, showing the location of regulatory devices such as BMPs, inlet protection, spill kits, signs, etc. This feature replaces the need for a physical, on-site map for regulatory purposes.

A Site mapping tool may provide the ability to customize a legend by company, division, or Site so that each User knows and is able to immediately identify Site components and features with icons, shapes, and colors when viewing or drawing on a Site map. Users may upload a map of their Site and edit the map by marking it up with overlay items such as graphics, text, lines, shapes, and notes. Overlay items can represent whatever the User configures them to represent, including assets, landmarks, boundaries, improvements, construction attributes, etc. These items may then be customized by the User who can add data such as Labels, ID's, annotations, etc.

The system may also display a detailed history report of all the historical actions that Users performed using the Site Map Tool.

The system may also provide functionality to automatically detect and delineate impervious surfaces from a satellite or overhead image. The system may also include the ability to identify utility and compliance-based features on a satellite or overhead image map such as storm drains, manholes, outfalls, detention ponds, channels, canals, waterways, waterbodies, etc.

GOAssets

In the GOAssets module, the Operator Editor can add, edit, view, and delete Site Logs, Site Notes, Documents, Artifacts, Permits, and other Workflow Elements for all their Company's Sites.

The Regulatory Editor can perform the same functions as The Operator Editor for Sites within their jurisdiction. Where Sites are not directly under the MS4 in ComplianceGO, they may be restricted to only the Municipal Versions of these Workflow Elements.

For all Sites they have been assigned, The Inspector and the Manager can add, edit, view, and delete Site Logs, Site Notes, Documents, Artifacts, Permits, and other Workflow Elements.

For all Sites they have been assigned, the Viewer can view Site Logs, Documents, Artifacts, Permits, and other Workflow Elements.

The third Party and the Citizen can view Site Logs, Documents, Artifacts, Permits, and Other Workflow Elements if granted access to the Public (View-Only) Interface.

The GOAssets module may be divided into three functions. These functions include Site logging, Site notes tool and Site documents, artifacts, workflows and permits.

The system may include a Site Log feature that allows for granular, common-repository log-keeping, and action tracking and reporting for all regulatory participants on a Site or Asset. The logs may be customizable so that the User can create as many logs as they need with the info that they need. The logs may be customizable to the needs of the User and may be updated on-demand as the Site progresses. The system makes the logs easy to use and in an electronic format.

Prior to the embodiments of the invention, Users were creating logs in word format or pdf and would have to download the log and then re-upload the log once it was updated. The embodiment of the invention simplifies the Site logging process by allowing them to be added to and created as needed.

A Site Notes Tool allows for the User to create custom notes that are helpful for the Site. This tool may allow files and pictures to be attached to the notes. The Site notes may help Users track and keep info that is not required in compliance documents but still helps the User fulfill the job. The Site notes may only be viewable based on Roles within the system.

Regulatory and project documents may be managed in the system based on the User who uploaded the document and that User's Role. Other Users and Non-System Users may be granted access to view the documents, but may not edit, delete, or otherwise alter the document.

Designated Users may be able to establish rules for managing the life cycle of a Site, including the regulatory permitting process, the automated creation and parameterization of a Site and/or its assets as well as all Site lifecycle activity based on permit data. For example, a new permit may be generated and issued through the permitting system and automated rules provide for a Site and/or its assets to be created, specific tasks to be generated, and/or notifications to be generated based on the permit information.

Dashboard(s) 10 such as the one shown in FIG. 1 may give a summary view of Site and permit data and status, which allows a User to know if permits are expiring or need to be renewed, as well as other summary data related to permits. The accessibility and configuration of the Dashboard 10 may be determined by the Role of the User as well as the User's personalized settings.

Permit documents may be digitally signed within the system and Users may be notified of permit deficiencies, renewals, signatures, content, and other requirements. Document and permit data may be summarized, viewed, and managed from a User's dashboard based on specific requirements, such as expiration or content. This allows the User to view and access permits and documents that require action.

For example, Sites with permits that are expiring soon, require signatures, require review, or document completion and review based on document title, category, or content.

This system may also include customizable reporting for Workflow Elements based on User-defined criteria. For example, the ability to add completed task reports directly to documents. For example, a task may be to complete the SWPPP. The SWPPP is completed in the task section like an inspection, then the assigning entity or User can review it and assign action items that need to be fixed. The assigned User can fix it and resubmit. Once the task has been accepted, the generated document may be automatically placed into the documents section with the approval information as an SWPPP document.

Documents may be amended through the documents section and Users can be notified when documents have been changed and be assigned tasks such as reviewing, accepting, or rejecting the document or changes.

GOManage

The GOManage module may include the functions of self-signup, self-manage, pay online and other management features like other SAAS products. Site logging, Site notes tool and Site documents, artifacts, workflows and permits.

In GOManage, the Operator Editor performs the day-to-day management of the system including creating Entities, Sites, Users, and Forms, assigning Roles, Inspections, Weather Events, and Notification Recipients, and editing any of these items.

For the Municipal side of the program, the Regulatory Editor performs all day-to-day management of the Municipal side of ComplianceGO including creating Entities, Sites, Users, and Forms, assigning Roles, Inspections, Weather Events, and Notification Recipients, and editing any of these items. For Divisions and Sites directly under the MS4, they additionally have all the functions of the Operator Editor.

The Inspector can assign and edit Notification Recipients. The Manager, the Viewer, the third Party, and the Citizen do not interact directly with the GoManage module other than to be granted access to Sites.

Turning to some examples of operation of the ComplianceGO software program, FIG. 7 is a flowchart that illustrates the workflow when an inspection must be performed at a Site. The steps include a determination that an inspection is due 90.

Notification is then sent to an Inspector 92 and at the same time, the Dashboard Status is updated 94. Maps and Directions are provided to the Inspector 96 so that the Inspector may travel to the Site. The Inspector then travels to the Site 98 where the Inspector uses an Interactive Form to do the inspection 100. One or more Action Items may be created 102 when using the Interactive Form. The Inspector completes the inspection 104, electronically signs an inspection report 106 and the system then sends the inspection report to the interested parties 108.

FIG. 8 is a diagram that explains how ownership of sub-entities and Sites works. However, the diagram is not intended to explain access to the common database of information that is stored in the Cloud.

FIG. 8 shows that the top of the ownership structure is a Director or Directors. The Directors may be consultants. The next lower level of ownership are the Companies, the Administrative companies and the MS4s. The Companies may be clients of the consultants, the Administrative companies may be private companies that are not under a consultant, and the MS4s may be cities, counties, and other Regulators. Below the Companies are Divisions of the Companies that may be in control of various projects. Finally, the Sites are at the bottom and are regulated and managed by the Administrative companies, the Companies, the MS4s and the Divisions of the Companies.

FIG. 9 is an Access Control flowchart. The flowchart explains who may have access to a Site.

A final element of the embodiments of the invention that should be clarified is the function and operation of an access control system that is needed to control access to the Cloud-based common database of information. The access control system uses access rights to provide the different Users with access to different portions of the Cloud-based common database. This feature may be an essential one of the embodiments of the invention. Sometimes the access rights may be pre-defined for a particular type of User. However, the ComplianceGO software program is also versatile and may allow editing of those access rights for any User by, for example, an Operator Editor and a Regulatory Editor. Thus, a User may receive expanded or contracted rights depending on what access is needed above or below the predefined rights.

The access control system also includes a User database for storing the different types of Users and the corresponding predefined access rights, wherein the access control system grants access to portions of the Cloud-based database in accordance with the type of User that is requesting access.

FIG. 10 illustrates some practical aspects of the embodiments of the invention. The System is comprised of a cloud-based computer system running the ComplianceGO software which accesses a cloud-based common database.

More specifically, the Cloud-based computer system 110 is shown as being connected to the Internet 116. The Cloud-based computer 110 includes a processor for executing computer software programs. The Cloud-based computer system 110 runs the ComplianceGO software program 120. The ComplianceGo software program 120 includes a plurality of software modules as explained previously. One of these modules is an ACCESS software module 112 that functions as an access control system and User database. The ACCESS software module 112 may control which Users have access to the cloud-based common database 114 which stores all of the data that is generated and stored by the ComplianceGO software program. The Cloud-based computer system 110 is in communication with the Internet 116 so that User computing devices 118 may access the ComplianceGO software program 120 through a User interface such as a web browser.

As a summary of a system that might be used to perform the regulatory compliance activities described above, the following information is provided. The embodiments of the invention may include a Cloud-based computer system for providing access to a common database holding relevant data regarding regulatory compliance of a Site.

A first element of the system is a Cloud-based common database for storing data regarding regulatory compliance regarding a project, wherein the database includes data that may be accessed by various Users.

An access control system is also needed to control access to the Cloud-based common database, wherein the access control system uses predefined access rights to provide different Users with access to different portions of the Cloud-based database. The access control system may be a software module of the ComplianceGO software program.

The access control system also includes a User database for storing different types of Users and the corresponding access rights, wherein the access control system grants access to portions of the Cloud-based database in accordance with the type of User that is requesting access.

Finally, a User interface is provided that gives access to the Cloud-based database, wherein the User interface may be displayed on a plurality of different computing devices, and wherein the interface may change depending on the computing device the interface is being shown. The interface may be a web browser that is accessing the ComplianceGO software program on the Cloud-based computer system 110.

The User interface is then operated on a computing device such that the computing device has access to the Cloud-based common database. The User then logs into the cloud-based computer system using the User interface, and then performs a function using the User interface, wherein the function is related to determining regulatory compliance of a project.

It was previously mentioned that the embodiments of the present invention may be used for a variety of different industries, both privately and publicly regulated, as well as corporate or private non-regulatory entities for use in internal processes and governance. Some further explanation is warranted. A company, either private or a government agency, may also adapt the embodiments of the invention for internal use only.

For example, consider a company that has its own internal rules or regulations. To make certain that all Divisions, Departments or Entities within the company are following the larger and all-encompassing company regulations, an auditing division within the company may be given the power to ensure compliance with internal company regulations by all other divisions within the company, by implementing the embodiments of the invention. In this regard, the Regulator may be defined as the Company Auditor, and the Regulatee that is being monitored may be defined as the Company Division.

Some of the software modules of the ComplianceGO software may not be applicable for use within a single company. For example, the GOWeather module may not be applicable. Nevertheless, even if some modules are not applicable, that would not prevent all other modules from operating as desired. Thus, a company could ensure compliance with its own regulations.

Another scenario is when two companies are working together on a project. The first company might be the owner of the project and the second company might be an outside contractor that is providing services to the first company. The first company may implement use of the ComplianceGO software to ensure that the second company is following all of the first company's internal regulations.

What is important to realize is that the embodiments of the invention are adaptable such that a strict Regulator/Regulatee relationship is not required in order to use the ComplianceGO software. Thus, the ComplianceGO software may be used to enforce compliance with rules and regulations of any source, be they government regulations or internal rules of a company.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

1. A system for providing access to a common database storing data regarding regulatory compliance for a Site, said system comprised of:
a Cloud-based computer system that executes a compliance software program, wherein the Cloud-based computer system is coupled to the Internet;
a Cloud-based common database coupled to the Cloud-based computer system for storing data regarding regulatory compliance of at least one Site, wherein the Cloud-based common database stores data from at least one Regulator and at least one Regulatee; and
an access control system running on the Cloud-based computer system, wherein the access control system provides Role-based User access to the Cloud-based common database such that the at least one Regulator and the at least one Regulatee can both access the Cloud-based common database.

2. The system as defined in claim 1 wherein the access control system is further comprised of a User database, wherein the access control system consults the User database to determine what data may be accessed by a User of the compliance software program.

3. The system as defined in claim 2 wherein the User database is further comprised of memory for storing a plurality of different Users, wherein the Users are selected from the group of Users comprised of an Operator Editor, a Regulatory Editor, an Inspector, a Manager, a Viewer, a Third party, and a Citizen.

4. The system as defined in claim 1 wherein the compliance software program is further comprised of a ComplianceGO software program that enables the access control program to maintain differentiated access to the Cloud-based common database for both the at least one Regulator and the at least one Regulatee.

5. The system as defined in claim 1 wherein the system is further comprised of:
a computing device that is coupled to the Internet; and
a web browser program that runs on the computing device, wherein the web browser accesses the compliance software program on the Cloud-based computer system.

6. The system as defined in claim 5 wherein the system further comprises selecting the computing device from the group of computing devices comprised of a mobile telephone, a tablet, a laptop, and a desktop computer.

7. A method for enabling regulatory compliance of a Site that is subject to a plurality of regulations by providing a common tool for use by a Regulator and a Regulatee, said method comprising:
providing a Cloud-based computer system that executes a compliance software program, wherein the Cloud-based computer system is coupled to the Internet;
providing a Cloud-based common database coupled to the Cloud-based computer system for storing data regarding regulatory compliance of at least one Site, wherein the Cloud-based common database stores data from at least one Regulator and at least one Regulatee;
providing an access control system running on the Cloud-based computer system, wherein the access control system provides Role-based User access to the Cloud-based common database such that the at least one Regulator and the at least one Regulatee can both access the Cloud-based common database; and
enforcing regulatory separation of duties of the at least one Regulator and the at least one Regulatee by only allowing differentiated access to the Cloud-based common database.

8. The method as defined in claim 7 wherein the method further comprises providing a plurality of software modules for the compliance software program to thereby implement a plurality of different functions within the compliance software program.

9. The method as defined in claim 8 wherein the method further comprises selecting the plurality of software modules from the group of software modules comprised of GOConnect, GOInspect, GOAdmin, GOManage, GOCorrect, GOWeather, GOForms, GOBranding, GOMaps, and GOAssets.

10. The method as defined in claim 7 wherein the method further comprises:
defining the Role of each User type so that each User type has access to the repository of assets, workflows, data, events, artifacts, and corrective actions stored in the Cloud-based common database; and
performing the functions needed to perform regulatory compliance or oversight.

11. The method as defined in claim 10 wherein the method further comprises:
enabling the at least one Regulator User to record the outcome of oversight, workflows, inspections, audits, and other regulatory tasks in the compliance software program;
enabling the at least one Regulatee User to record the outcome of administrative functions, inspections, corrective action tasks, and other regulatory tasks in the compliance software program; and
providing dashboards in the compliance software program that enable Users to be able to determine the status of a Site in real-time.

12. The method as defined in claim 7 wherein the method further comprises providing access to data in the Cloud-based common database to a person who is not a User and has no User account in the compliance software program.

13. The method as defined in claim 12 wherein the method of providing access to data in the Cloud-based common database to a person who is not a User further comprises transmitting a message to the person who is not a User, wherein the message contains a web-based link that authorizes limited access to data in the Cloud-based common database, or authorizes the person to perform at least one task within the compliance software program.

14. The method as defined in claim 9 wherein the method further comprises using the GOWeather module in the compliance software program to perform the functions of:
automatically importing weather data from third party weather sources including spatial data; and
converting the spatial data into pinpoint textual data to thereby provide weather results within 1 meter of geographical location for any Site.

15. The method as defined in claim 14 wherein the method further comprises using the precise weather forecasting of the GOWeather module to trigger User notifications, weather events and proactive User-notifying events.

16. The method as defined in claim 10 wherein the method further comprises selecting the User types from the group of User types comprised of an Operator Editor, a Regulatory Editor, an Inspector, a Manager, a Viewer, a Third party, and a Citizen.

17. The method as defined in claim 7 wherein the method further comprises:
providing a User database; and
enabling the access control system to access the User database to determine what data may be accessed by the at least one Regulator and by the at least one Regulatee.

18. The method as defined in claim 7 wherein the compliance software program further comprises:
providing a ComplianceGO software program; and
maintaining differentiated access to the Cloud-based common database for both the at least one Regulator and the at least one Regulatee.

19. The method as defined in claim 18 wherein the method further comprises:
enabling the at least one Regulator to have at least partial access to the functions of the at least one Regulatee; and
enabling the at least one Regulatee to have at least partial access to the functions of the at least one Regulator.

20. The method as defined in claim 16 wherein the method further comprises providing backup Role support for each of the different User types, such that a different User type may be given rights in order to perform the functions of another User type.

21. (canceled)

22. The method as defined in claim 16 wherein the method further comprises providing a custom form builder that enables the User to build a custom form in order to complete a specific function of the User.

23. (canceled)

24. (canceled)

25. (canceled)

26. (canceled)

27. The method as defined in claim 22 wherein the method further comprises providing decision tree and rule-based support of data in the custom form.

28. The method as defined in claim 27 wherein the method further comprises enabling complex task form logic, wherein tasks may be assigned scores and weighting of scores.

29. (canceled)

30. (canceled)

31. The method as defined in claim 9 wherein the method further comprises enabling an overlay of civil plans directly onto a satellite view of a Site map in the GOMaps module.

32. The method as defined in claim 31 wherein the method further comprises customizing a legend of a map of the Site by company, division, or Site so that each User can identify Site components and features with icons, shapes, and colors when viewing or drawing on the Site map.

33. (canceled)

34. (canceled)

35. (canceled)

36. The method as defined in claim 9 wherein the method further comprises selecting GOManage features from the group of features comprised of self-signup, self-manage, pay online and other management features in SAAS products.

37. The method as defined in claim 19 wherein the method further comprises:
completing the functions separately of the at least one Regulator and the at least one Regulatee; and
enabling the at least one Regulator and the at least one Regulatee to see data generated by the other in real-time to thereby maintain Site compliance.

38. (canceled)

39. The method as defined in claim 9 wherein the method further comprises:
configuring and granting User permissions on an individual basis;
configuring and granting User permissions based on selected inheritance and the User's Role or affiliation to an Entity.

40. (canceled)

41. (canceled)

42. (canceled)

43. A method for enabling regulatory compliance of a Site that is subject to a plurality of regulations by providing a common tool for use by a Regulator and a Regulatee, said method comprising:
providing a Cloud-based computer system that executes a compliance software program, wherein the Cloud-based computer system is coupled to the Internet;
providing a Cloud-based common database coupled to the Cloud-based computer system for storing data regarding regulatory compliance of at least one Site, wherein the Cloud-based common database stores data from at least one Regulator and at least one Regulatee;
providing an access control system running on the Cloud-based computer system, wherein the access control system provides Role-based User access to the Cloud-based common database such that the at least one Regulator and the at least one Regulatee can both access the Cloud-based common database;
providing a weather module for accessing third party weather data for an area around the at least one Site and generating more weather data that is specific for the at least one Site; and
enforcing regulatory separation of duties of the at least one Regulator and the at least one Regulatee by only allowing differentiated access to the Cloud-based common database.

44. (canceled)

45. A method for enabling rules regulatory compliance of a Division within a Company that is subject to a plurality of company rules by providing a common tool for use by a Company Auditor and the Company Division, said method comprising:
providing a Cloud-based computer system that executes a compliance software program, wherein the Cloud-based computer system is coupled to the Internet;
providing a Cloud-based common database coupled to the Cloud-based computer system for storing data regarding rules compliance of a Company Division, wherein the Cloud-based common database stores data from a Company Auditor and the Company Division;
providing an access control system running on the Cloud-based computer system, wherein the access control system provides Role-based User access to the Cloud-based common database such that the Company Auditor and the Company Division can both access the Cloud-based common database; and
enforcing separation of duties of the Company Auditor and the Company Division by only allowing differentiated access to the Cloud-based common database.

46. (canceled)
